(19) United States
(12) Patent Application Publication
(10) Pub. No.: US 2026/0188098 A1
(43) Pub. Date: Jul. 2, 2026

(54) SYSTEM FOR INTELLIGENT CENTRAL MONITORING AND ALARMING OF BODY TEMPERATURE

(71) Applicant: Tongji Hospital of Tongji Medical College of Huazhong University of Science and Technology, Wuhan (CN)

(72) Inventors: Zhenyun ZHU, Wuhan (CN); Chengshuang WANG, Wuhan (CN); Bingxin MENG, Wuhan (CN); Zeping XU, Wuhan (CN)

(21) Appl. No.: 19/432,257

(22) Filed: Dec. 24, 2025

(30) Foreign Application Priority Data
Jan. 2, 2025 (CN) 2025100006275

(51) Int. Cl. G08B 21/18; G08B 21/02; G08B 25/10; G08B 25/14; G08B 29/20; H04W 4/029; H04W 4/38; H04W 4/90

(52) U.S. Cl. CPC G08B 21/182; G08B 21/02; G08B 25/10; G08B 25/14; G08B 29/20; H04W 4/029; H04W 4/38; H04W 4/90

(57) ABSTRACT

Disclosed is a system for intelligent central monitoring and alarming of a body temperature, which relates to the technical field of medical instruments. The system includes extracting a first body temperature sensor in distributed body temperature sensors, and obtaining a first real-time body temperature of a target user through the first body temperature sensor; invoking a predetermined transmission strategy, and transmitting the first real-time body temperature to a data processing center according to the predetermined transmission strategy; activating a predetermined data calibration mechanism in an internal memory in the data processing center, and calibrating the first real-time body temperature according to the predetermined data calibration mechanism, so as to obtain a first effective real-time body temperature; and displaying the first effective real-time body temperature in a visualized manner.

### TECHNICAL FIELD

The disclosure relates to the technical field of medical instruments, and particularly relates to a system for intelligent central monitoring and alarming of a body temperature.

### BACKGROUND

At present, temperature monitoring technologies are facing challenges of real-time, continuous and remote monitoring. Traditional body temperature monitoring methods, such as mercury thermometers and electronic thermometers, can only measure body temperatures intermittently, and fail to track a body temperature of a target user in real time and continuously. Such methods generally have problems of long measurement intervals and incapability to find abnormal changes of the body temperature in time. Body temperature monitoring methods in the prior art generally lack an effective calibration and automatic alarming mechanism of body temperature data, which makes it impossible to give early warning in time when an abnormal body temperature appears. This will affect health monitoring of the target user.

### SUMMARY

The disclosure provides a system for intelligent central monitoring and alarming of a body temperature, so as to solve technical problems of incapability to implement real-time, continuous and remote monitoring in body temperature monitoring and lack of an effective body temperature calibration and alarming mechanism in the prior art.

In view of the above problems, the disclosure provides a system for intelligent central monitoring and alarming of a body temperature.

The disclosure provides a system for intelligent central monitoring and alarming of a body temperature. The system includes:
an intelligent wearable body temperature monitoring device, where the intelligent wearable body temperature monitoring device is configured to extract a first body temperature sensor in distributed body temperature sensors, and obtain a first real-time body temperature of a target user through the first body temperature sensor, where the first real-time body temperature corresponds to a first human body part of the target user; a data transmission module, where the data transmission module is configured to invoke a predetermined transmission strategy, and transmit the first real-time body temperature to a data processing center according to the predetermined transmission strategy; a central management platform, where the central management platform is configured to activate a predetermined data calibration mechanism in an internal memory in the data processing center, and calibrate the first real-time body temperature according to the predetermined data calibration mechanism, so as to obtain a first effective real-time body temperature; and an information display device, where the information display device is configured to display the first effective real-time body temperature in a visualized manner.

One or more technical solutions provided by the disclosure at least have the following technical effects or advantages:

The disclosure extracts the first body temperature sensor in the distributed body temperature sensors, and obtains the first real-time body temperature of the target user through the first body temperature sensor; invokes the predetermined transmission strategy, and transmits the first real-time body temperature to the data processing center according to the predetermined transmission strategy; activates the predetermined data calibration mechanism in the internal memory in the data processing center, and calibrates the first real-time body temperature according to the predetermined data calibration mechanism, so as to obtain the first effective real-time body temperature; and displays the first effective real-time body temperature in a visualized manner. The disclosure solves technical problems of incapability to implement real-time, continuous and remote monitoring in body temperature monitoring and lack of an effective body temperature calibration and alarming mechanism in the prior art. A real-time body temperature of the target user is obtained through the distributed body temperature sensors, and data is transmitted to the data processing center through the data transmission module. The central management platform activates the predetermined data calibration mechanism to calibrate body temperature data, so as to obtain an effective real-time body temperature. The information display device displays the calibrated body temperature data in a visualized manner. Thus, continuous monitoring, remote transmission and real-time visualization of the body temperature are implemented, and technical effects of improving efficiency and accuracy of body temperature monitoring are achieved.

### BRIEF DESCRIPTION OF THE DRAWINGS

To describe technical solutions in embodiments of the disclosure more clearly, accompanying drawings required for describing the embodiments are briefly described below. Obviously, the accompanying drawings in the following description show merely some embodiments of the disclosure, and those of ordinary skill in the art would also be able to derive other accompanying drawings from these accompanying drawings without creative efforts.

FIG. 1 is a schematic structural diagram of a system for intelligent central monitoring and alarming of a body temperature according to an embodiment of the disclosure.

FIG. 2 is a schematic structural diagram of a central management platform of a system for intelligent central monitoring and alarming of a body temperature according to an embodiment of the disclosure.

Description of the reference numbers: intelligent wearable body temperature monitoring device 11, data transmission module 12, central management platform 13, and information display device 14.

### DETAILED DESCRIPTIONS OF THE EMBODIMENTS

The disclosure provides a system for intelligent central monitoring and alarming of a body temperature, so as to solve technical problems of incapability to implement real-time, continuous and remote monitoring in body temperature monitoring and lack of an effective body temperature calibration and alarming mechanism in the prior art. A real-time body temperature of a target user is obtained through distributed body temperature sensors, and data is transmitted to a data processing center through a data transmission module. A central management platform activates a predetermined data calibration mechanism to calibrate body temperature data, so as to obtain an effective real-time body temperature. An information display device displays the calibrated body temperature data in a visualized manner. Thus, continuous monitoring, remote transmission and real-time visualization of the body temperature are implemented, and technical effects of improving efficiency and accuracy of body temperature monitoring are achieved.

Technical solutions in embodiments of the disclosure will be clearly and completely described below with reference to the drawings in the embodiments of the disclosure. Obviously, the embodiments described are merely some embodiments rather than all embodiments of the disclosure. Based on the embodiments of the disclosure, all other embodiments obtained by those of ordinary skill in the art without making creative efforts fall within the protection scope of the disclosure.

It should be noted that any variations of terms “comprise”, “include”, and “have” are intended to cover non-exclusive inclusions, and for example, processes, methods, systems, products, or servers that include a series of steps or units are not necessarily limited to the explicitly listed steps or units, and may include other steps or modules not explicitly listed or inherent to these processes, methods, products, or devices.

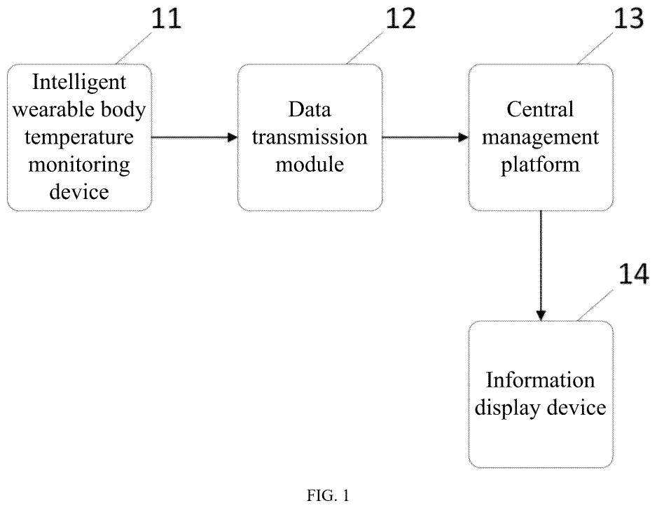

In embodiments, as shown in FIG. 1, the embodiments of the disclosure provide a system for intelligent central monitoring and alarming of a body temperature. The system includes:
an intelligent wearable body temperature monitoring device 11. The intelligent wearable body temperature monitoring device 11 is configured to extract a first body temperature sensor in distributed body temperature sensors, and obtain a first real-time body temperature of a target user through the first body temperature sensor. The first real-time body temperature corresponds to a first human body part of the target user.

In the embodiment of the disclosure, the intelligent wearable body temperature monitoring device monitors a body temperature of the target user in real time through the plurality of distributed body temperature sensors. The plurality of distributed body temperature sensors are distributed in different parts, such as an armpit and a chest, of a monitoring target. The body temperature of the target user is monitored through the first body temperature sensor in the distributed body temperature sensors, and the first real-time body temperature of the target user is obtained. The first body temperature sensor refers to any body temperature sensor in the distributed body temperature sensors. Each body temperature sensor is configured to monitor body temperatures of different parts of the target user.

The first real-time body temperature obtained through monitoring corresponds to the first human body part of the target user. For example, a real-time body temperature detected by a body temperature sensor distributed at the armpit is a temperature at the armpit of the target user.

Further, in the system provided by the embodiment of the disclosure, the intelligent wearable body temperature monitoring device 11 further includes:
a real-time body temperature time sequence obtaining module, where the real-time body temperature time sequence obtaining module is configured to obtain a first real-time body temperature time sequence of the first human body part through the first body temperature sensor; a regression fitting module, where the regression fitting module is configured to perform polynomial regression fitting on a first body temperature scatter diagram drawn according to the first real-time body temperature time sequence, so as to obtain a first fitting formula; and a real-time body temperature checking module, where the real-time body temperature checking module is configured to analyze the first fitting formula to obtain a first real-time predicted body temperature, and check the first real-time body temperature through the first real-time predicted body temperature.

In the embodiment of the disclosure, firstly, the real-time body temperature time sequence obtaining module continuously monitors body temperature changes of the target user through the first body temperature sensor. The real-time body temperature time sequence obtaining module is configured to obtain the first real-time body temperature time sequence of the target user in a period. The first real-time body temperature time sequence refers to one continuous body temperature data sequence, and records changes of the body temperature of the first human body part (such as an armpit and a chest) of the target user in a certain period.

Then, the regression fitting module is configured to perform deeper analysis on first real-time body temperature time sequence data. The regression fitting module firstly draws the first body temperature scatter diagram based on the first real-time body temperature time sequence. Each point in the scatter diagram represents body temperature data at a certain moment. Through the scatter diagrams, a changing trend of body temperatures with time may be directly seen. Then, the regression fitting module uses a polynomial regression algorithm to perform fitting on data in the first body temperature scatter diagram, so as to generate the first fitting formula.

Finally, the real-time body temperature checking module further verifies the collected body temperature data to ensure accuracy and reliability of the body temperature data. A working principle of the module is as follows: The first real-time predicted body temperature of the target user at a certain moment is predicted through analysis of the first fitting formula generated by regression fitting. Then, the predicted body temperature is compared with the first real-time body temperature actually collected. Specifically, after the body temperature data is collected, an expected body temperature of the target user at the identical moment is predicted through a fitting curve generated by regression fitting, that is, the first fitting formula, and the first real-time predicted body temperature is obtained. If there is a significant difference between an actually-measured body temperature and the predicted body temperature, a checking mechanism is triggered to perform re-collection. In this case, if a difference between the measured body temperature and the predicted body temperature exceeds 0.5° C., it is considered that the measurement is abnormal. Then, the body temperature data is automatically re-collected, and the measured data is re-checked to ensure accuracy of the data.

Further, in the system provided by the embodiment of the disclosure, the intelligent wearable body temperature monitoring device 11 further includes:
a circuit wake-up module, where the circuit wake-up module is configured to activate a timed wake-up circuit, and the timed wake-up circuit is provided with an identifier of a predetermined time interval; and a body temperature monitoring module, where the body temperature monitoring module is configured to wake up the first body temperature sensor to perform dynamic body temperature monitoring on the first human body part based on the predetermined time interval, so as to obtain the first real-time body temperature time sequence.

In the embodiment of the disclosure, the circuit wake-up module and the body temperature monitoring module cooperate with each other, so as to ensure that the body temperature data can be dynamically monitored in the predetermined time interval, and further an accurate real-time body temperature time sequence can be obtained.

Specifically, a function of the circuit wake-up module is to activate the timed wake-up circuit. The circuit is provided with the identifier of the predetermined time interval, which is configured to automatically wake up the body temperature sensor in a specific time interval. The time interval is preset as required. For example, the body temperature sensor is automatically activated at set intervals (such as 30 seconds, 1 minute, or 2 minutes). In this way, the device may measure the body temperature regularly without manual intervention of the user. A design of the timed wake-up circuit not only ensures continuous collection of the body temperature data, but also effectively manages battery consumption, because a sensor is activated only when necessary. This avoids energy waste caused by continuous operation.

When the timed wake-up circuit is triggered, the body temperature monitoring module immediately executes a wake-up operation to activate the first body temperature sensor. In this case, the body temperature sensor is woken up and begins to measure the body temperature of the first human body part of the target user. The body temperature monitoring module periodically wakes up the body temperature sensor according to the predetermined time interval, and collects the body temperature data of the user in real time. The body temperature data collected each time may form one continuous body temperature data sequence, that is, the first real-time body temperature time sequence.

The system further includes a data transmission module 12. The data transmission module 12 is configured to invoke a predetermined transmission strategy, and transmit the first real-time body temperature to a data processing center according to the predetermined transmission strategy.

Further, in the system provided by the embodiment of the disclosure, the data transmission module performs data transmission through Bluetooth, wireless fidelity (WiFi), or a radio frequency technology at a specific frequency band.

In the embodiment of the disclosure, the data transmission module invokes the predetermined transmission strategy. The predetermined transmission strategy is a preset rule and determines how to process and transmit the body temperature data, which includes a data transmission mode, frequency, and security measures. Specifically, the predetermined transmission strategy stipulates encrypted transmission of the body temperature data to ensure that the data cannot be stolen or tampered with by unauthorized third parties in a transmission process. Implementation of the encrypted transmission generally uses a symmetric encryption algorithm, and for example, an advanced encryption standard (AES). The encryption mode ensures security of the data, has an efficient and fast processing capability, and is suitable for real-time transmission.

Once the data is encrypted, the data transmission module may transmit first real-time body temperature data to the data processing center in a set communication mode according to the predetermined transmission strategy. In the disclosure, the data transmission module may perform data transmission in various radio communication modes, such as Bluetooth, WiFi, or other radio frequency technologies at specific frequency bands.

The system further includes a central management platform 13. The central management platform 13 is configured to activate a predetermined data calibration mechanism in an internal memory in the data processing center, and calibrate the first real-time body temperature according to the predetermined data calibration mechanism, so as to obtain a first effective real-time body temperature.

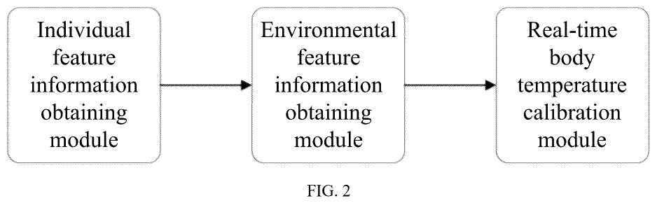

Further, as shown in FIG. 2, in the system provided by the embodiment of the disclosure, the central management platform 13 further includes:
an individual feature information obtaining module, where the individual feature information obtaining module is configured to obtain target multidimensional individual feature information of the target user; an environmental feature information obtaining module, where the environmental feature information obtaining module is configured to obtain target multidimensional environmental feature information of the target user; and a real-time body temperature calibration module, where the real-time body temperature calibration module is configured to calibrate the first real-time body temperature based on the predetermined data calibration mechanism in combination with the target multidimensional individual feature information and the target multidimensional environmental feature information, so as to obtain the first effective real-time body temperature. The target multidimensional individual feature information includes feature information of a target individual basic dimension, a target individual physiological state dimension, and a target individual psychological state dimension. The target individual basic dimension at least includes an individual age and an individual gender. The target individual physiological state dimension at least includes a physical activity, a disease state, an endocrine condition, a diet and drug condition, and a sleep state. The target individual psychological state dimension at least includes an emotional fluctuation and a biological rhythm. The target multidimensional environmental feature information includes an external temperature, an external humidity, and an external air pressure.

In the embodiment of the disclosure, the central management platform activates the predetermined data calibration mechanism in the internal memory in the data processing center. The first real-time body temperature is calibrated according to the predetermined data calibration mechanism, so as to obtain the first effective real-time body temperature.

Specifically, firstly, the individual feature information obtaining module obtains the target multidimensional individual feature information of the target user. The target multidimensional individual feature information includes the feature information of the target individual basic dimension, the target individual physiological state dimension, and the target individual psychological state dimension. The target individual basic dimension at least includes the individual age and the individual gender. The target individual physiological state dimension at least includes the physical activity, the disease state, the endocrine condition, the diet and drug condition, and the sleep state. The target individual psychological state dimension at least includes the emotional fluctuation and the biological rhythm. In order to obtain target individual basic dimension information, an age and a gender of the target user are obtained by extracting a health file of the target user. The target individual physiological state dimensions, such as the physical activity, the disease state, and the endocrine condition, are continuously tracked through a health monitoring device worn by the user, such as a smart watch, so as to obtain an activity level and a health condition of the target user in real time. The target individual psychological state dimensions, such as the emotional fluctuation and the biological rhythm, are detected through a self-narration of the target user or an intelligent device, such as a pressure sensing device.

Then, the environmental feature information obtaining module obtains the target multidimensional environmental feature information of the target user. The target multidimensional environmental feature information includes the external temperature, the external humidity, and the external air pressure. The information is collected in real time through a thermo-hygrometer, an environmental humidity sensor, and a meteorological sensor (such as a barometer).

Once the target multidimensional individual feature information and the target multidimensional environmental feature information are obtained, the real-time body temperature calibration module calibrates the first real-time body temperature based on the predetermined data calibration mechanism in combination with the target multidimensional individual feature information and the target multidimensional environmental feature information, so as to obtain the first effective real-time body temperature.

Further, in the system provided by the embodiment of the disclosure, the central management platform 13 further includes:
a standard extraction module, where the standard extraction module is configured to sequentially extract a predetermined individual standard and a predetermined environmental standard in the predetermined data calibration mechanism; a plan reading module, where the plan reading module is configured to read a feature vectorization plan; a first vectorization module, where the first vectorization module is configured to sequentially perform vectorization on the predetermined individual standard and the target multidimensional individual feature information according to the feature vectorization plan, so as to obtain an individual standard vector and a target individual vector respectively; a second vectorization module, where the second vectorization module is configured to sequentially perform vectorization on the predetermined environmental standard and the target multidimensional environmental feature information according to the feature vectorization plan, so as to obtain an environmental standard vector and a target environmental vector respectively; and a real-time body temperature weighted-calibration module, where the real-time body temperature weighted-calibration module is configured to perform weighted calibration on the first real-time body temperature with an individual similarity coefficient between the individual standard vector and the target individual vector and an environmental similarity coefficient between the environmental standard vector and the target environmental vector as weights, so as to obtain the first effective real-time body temperature.

In the embodiment of the disclosure, firstly, the standard extraction module extracts an individual standard and an environmental standard from the predetermined data calibration mechanism. The individual standards generally include physiological features such as an age, a gender, and a health condition. The environmental standards include external environmental conditions such as a temperature, a humidity, and an air pressure. The predetermined individual standard generally obtains a standard value suitable for most individuals based on standard body temperature data of healthy people by considering an average age, a gender, a health state and other factors of a group. The predetermined environmental standard extracts suitable environmental data, such as a temperature, a humidity, and an air pressure, based on a local climate, seasonal changes and other factors.

Then, the plan reading module reads the feature vectorization plan and provides a processing rule for subsequent vectorization. A plan file generally uses a standard format (such as JavaScript object notation (JSON) or extensible markup language (XML)), and includes a rule on how to perform vectorization on individual features and environmental features. The file specifies which features need vectorization and how to quantify the features (for example, dividing ages into different intervals, expressing genders in binary, expressing physical activity intensities in classified values, etc.), and defines a corresponding numerical value of each feature. By reading the rules, different individual and environmental data are processed according to predetermined standards.

Then, the first vectorization module performs vectorization on the predetermined individual standard and the target multidimensional individual feature information of the target user according to the feature vectorization plan. Firstly, basic information such as ages and genders of individuals is transformed into numerical vectors. The ages may be directly input as numerical values, and the genders may be expressed in binary (for example, 1 represents male, and 0 represents female). Secondly, for physiological state information such as the physical activity, the disease state, and the endocrine condition, the data is converted into numerical values through similar methods. For example, the physical activity may be expressed as 0, 1 and 2 by “low/medium/high” respectively, and information such as physiological states may be expressed as numerical values in this mode. In this way, through a standardization process, the system generates the individual standard vector and an individual feature vector of the target user, thus forming numerical data used for subsequent calculation.

Then, the second vectorization module performs similar vectorization on the environmental standard and target environmental feature information. Through the collected environmental data, such as a temperature, a humidity, and an air pressure, the information is converted into a numerical form according to a rule of the feature vectorization plan. For example, actual values of an environmental temperature and humidity may be directly taken, and the air pressure may be converted into a standard air pressure unit to generate the environmental standard vector and a target environmental feature vector.

The real-time body temperature weighted-calibration module performs weighted calibration on the first real-time body temperature with the similarity coefficients between the individual standard vector and the target individual vector and between the environmental standard vector and the target environmental vector as the weights. The similarity coefficient between the individual standard vector and the target individual vector is the individual similarity coefficient. In order to obtain the individual similarity coefficient, firstly, a cosine similarity method is used to calculate a similarity between the individual standard vector and the target individual vector. Then, a vector consistency number is calculated. That is, a number of identical items between the individual standard vector and the target individual vector in each feature dimension is compared, and a ratio of the consistency number to a total dimension number is calculated to obtain a second similarity. Finally, an average value of a first similarity and the second similarity is used as the individual similarity coefficient. The environmental similarity coefficient between the environmental standard vector and the target environmental vector is calculated through a cosine similarity principle.

Finally, the real-time body temperature weighted-calibration module performs weighted calibration on the first real-time body temperature through the individual similarity coefficient and the environmental similarity coefficient, so as to obtain the first effective real-time body temperature. Specifically, the individual similarity coefficient and the environmental similarity coefficient are multiplied by the first effective real-time body temperature respectively to obtain weighted values. Then, the weighted values are added, and finally an average value is taken to obtain a final first effective real-time body temperature.

Further, in the system provided by the embodiment of the disclosure, the central management platform 13 further includes:
a first similarity calculation module, where the first similarity calculation module is configured to calculate a similarity between the individual standard vector and the target individual vector through a cosine similarity principle, so as to obtain a first similarity; a second similarity calculation module, where the second similarity calculation module is configured to count a vector consistency number of the individual standard vector and the target individual vector, obtain a ratio of the vector consistency number to a total vector number, and record the ratio as a second similarity; and an individual similarity coefficient obtaining module, where the individual similarity coefficient obtaining module is configured to take an average value of the first similarity and the second similarity, and record the average value as the individual similarity coefficient.

In the embodiment of the disclosure, the first similarity calculation module calculates the similarity between the individual standard vector and the target individual vector through the cosine similarity principle. Specifically, the individual standard vector represents features of a standard individual in a plurality of dimensions, and the target individual vector represents features of the target user in an identical dimension. A cosine similarity between the two vectors is calculated through the cosine similarity principle, and the first similarity is obtained. The first similarity reflects an overall similarity between a target individual and a standard individual in a feature dimension.

Then, the second similarity calculation module counts the vector consistency number of the individual standard vector and the target individual vector. The vector consistency number refers to whether the values of two vectors are consistent in each dimension, that is, whether two vectors have an identical numerical value in the identical dimension. If the numerical values in a certain dimension are identical, the item is recorded as a consistent item. After consistent items in all dimensions are counted, the consistency number is obtained. Then, the ratio of the consistency number to the total dimension number of the vectors is calculated to obtain the second similarity.

Finally, the individual similarity coefficient obtaining module takes the average value of the first similarity and the second similarity, and records the average value as the individual similarity coefficient. Specifically, the individual similarity coefficient is obtained by summing the first similarity and the second similarity and then dividing the sum by two.

The system further includes an information display device 14. The information display device 14 is configured to display the first effective real-time body temperature in a visualized manner.

In the embodiment of the disclosure, the information display device presents the first effective real-time body temperature through a display interface, such that a worker can quickly and intuitively understand a body temperature change trend and a current state of the target user conveniently. Through intuitive charts, temperature change curves, lists and other forms, a body temperature fluctuation of the target user is displayed, and whether the body temperature is beyond a normal range is monitored in real time. In addition, the interface may further display other related information, such as a name, an age and other basic information of the target user.

Further, the system provided by the embodiment of the disclosure further includes an intelligent alarming module. The intelligent alarming module specifically includes:
a body temperature threshold determination module, where the body temperature threshold determination module is configured to determine whether the first effective real-time body temperature satisfies a predetermined body temperature threshold; an alarming signal sending module, where the alarming signal sending module is configured to send an alarming signal if the first effective real-time body temperature does not satisfy the predetermined body temperature threshold; and an abnormality alarming module, where the abnormality alarming module is configured to invoke a predetermined alarming mechanism based on the alarming signal, so as to provide a body temperature abnormality alarm of the target user. The predetermined alarming mechanism reminds a worker at least through sound, flashing, and a pop-up window.

In the embodiment of the disclosure, the body temperature threshold determination module is configured to determine whether the first effective real-time body temperature satisfies the predetermined body temperature threshold. The predetermined body temperature threshold includes a high temperature threshold and a low temperature threshold, which are used to determine whether the body temperature is too high or too low respectively. If the first effective real-time body temperature exceeds the normal range, it is considered that the body temperature is abnormal. Threshold determination is set based on clinical medical standards. For example, a normal body temperature of an adult ranges from 36.3° C. to 37.2° C. If the body temperature is lower than 36.3° C. or higher than 37.2° C., it may indicate that the body temperature is abnormal.

If the first effective real-time body temperature exceeds the predetermined body temperature threshold, the alarming signal sending module immediately sends the alarming signal and sends the alarming signal to the abnormality alarming module. After receiving the alarming signal, the abnormality alarming module further invokes the predetermined alarming mechanism and sends out a specific body temperature abnormality alarm. The predetermined alarming mechanism includes sound alarming, red light flashing, pop-up window reminding, etc., so as to ensure that the worker can notice an abnormal body temperature of the target user in time during busy work.

Further, in the system provided by the embodiment of the disclosure, the intelligent alarming module is further configured to obtain real-time positioning information of the target user through a positioning sensor, and add the real-time positioning information to the body temperature abnormality alarm.

In the embodiment of the disclosure, the intelligent alarming module obtains the real-time positioning information of the target user through the positioning sensor, and adds the real-time positioning information to the body temperature abnormality alarm. Specifically, a position of the target user is tracked in real time through the positioning sensor generally through a global positioning system (GPS), Wi-Fi, or a Bluetooth positioning technology. The positioning information includes a specific position where the user is currently located. When the system detects the abnormal body temperature of the target user, the real-time positioning information and the body temperature abnormality alarm of the target user are displayed or sent to the worker, such that the worker can quickly locate the position of the target user and take corresponding measures.

In the embodiment of the disclosure, in conclusion, the embodiment of the disclosure at least has the following technical effects:

The disclosure extracts the first body temperature sensor in the distributed body temperature sensors, and obtains the first real-time body temperature of the target user through the first body temperature sensor; invokes the predetermined transmission strategy, and transmits the first real-time body temperature to the data processing center according to the predetermined transmission strategy; activates the predetermined data calibration mechanism in the internal memory in the data processing center, and calibrates the first real-time body temperature according to the predetermined data calibration mechanism, so as to obtain the first effective real-time body temperature; and displays the first effective real-time body temperature in a visualized manner. The disclosure solves technical problems of incapability to implement real-time, continuous and remote monitoring in body temperature monitoring and lack of an effective body temperature calibration and alarming mechanism in the prior art. A real-time body temperature of the target user is obtained through the distributed body temperature sensors, and data is transmitted to the data processing center through the data transmission module. The central management platform activates the predetermined data calibration mechanism to calibrate body temperature data, so as to obtain an effective real-time body temperature. The information display device displays the calibrated body temperature data in a visualized manner. Thus, continuous monitoring, remote transmission and real-time visualization of the body temperature are implemented, and technical effects of improving efficiency and accuracy of body temperature monitoring are achieved.

It should be noted that sequences of the embodiments of the disclosure are only for description and do not indicate advantages and disadvantages of the embodiments. In addition, specific embodiments of the disclosure are described above. Processes depicted in the drawings do not necessarily require a specific sequence and a continuous sequence shown to achieve a desired result. In some implementations, multitasking and parallel processing are also possible or may be advantageous.

What are described above are merely preferred embodiments of the disclosure, and are not intended to limit the disclosure. Any modification, equivalent replacement, or improvement made within the spirit and principle of the disclosure shall fall within the protection scope of the disclosure.

The description and drawings are only illustrative of the disclosure, and are deemed to cover any and all modifications, variations, combinations or equivalents within the scope of the disclosure. Apparently, those skilled in the art may make various changes and variations to the disclosure without departing from the scope of the disclosure. In this way, if these modifications and variations of the disclosure fall within the scope of the disclosure and its equivalent technologies, the disclosure is intended to include these modifications and variations. What is claimed is:

1. A system for intelligent central monitoring and alarming of a body temperature, comprising:
an intelligent wearable body temperature monitoring device, wherein the intelligent wearable body temperature monitoring device is configured to extract a first body temperature sensor in distributed body temperature sensors, and obtain a first real-time body temperature of a target user through the first body temperature sensor, wherein the first real-time body temperature corresponds to a first human body part of the target user;
a data transmission module, wherein the data transmission module is configured to invoke a predetermined transmission strategy, and transmit the first real-time body temperature to a data processing center according to the predetermined transmission strategy;
a central management platform, wherein the central management platform is configured to activate a predetermined data calibration mechanism in an internal memory in the data processing center, and calibrate the first real-time body temperature according to the predetermined data calibration mechanism, so as to obtain a first effective real-time body temperature; and
an information display device, wherein the information display device is configured to display the first effective real-time body temperature in a visualized manner, wherein
the central management platform further comprises an individual feature information obtaining module, wherein the individual feature information obtaining module is configured to obtain target multidimensional individual feature information of the target user;
an environmental feature information obtaining module, wherein the environmental feature information obtaining module is configured to obtain target multidimensional environmental feature information of the target user; and
a real-time body temperature calibration module, wherein the real-time body temperature calibration module is configured to calibrate the first real-time body temperature based on the predetermined data calibration mechanism in combination with the target multidimensional individual feature information and the target multidimensional environmental feature information, so as to obtain the first effective real-time body temperature, wherein
the target multidimensional individual feature information comprises feature information of a target individual basic dimension, a target individual physiological state dimension, and a target individual psychological state dimension, the target individual basic dimension at least comprises an individual age and an individual gender, the target individual physiological state dimension at least comprises a physical activity, a disease state, an endocrine condition, a diet and drug condition, and a sleep state, and the target individual psychological state dimension at least comprises an emotional fluctuation and a biological rhythm; and
the target multidimensional environmental feature information comprises an external temperature, an external humidity, and an external air pressure;
the central management platform further comprises a standard extraction module, wherein the standard extraction module is configured to sequentially extract a predetermined individual standard and a predetermined environmental standard in the predetermined data calibration mechanism;
a plan reading module, wherein the plan reading module is configured to read a feature vectorization plan;
a first vectorization module, wherein the first vectorization module is configured to sequentially perform vectorization on the predetermined individual standard and the target multidimensional individual feature information according to the feature vectorization plan, so as to obtain an individual standard vector and a target individual vector respectively;
a second vectorization module, wherein the second vectorization module is configured to sequentially perform vectorization on the predetermined environmental standard and the target multidimensional environmental feature information according to the feature vectorization plan, so as to obtain an environmental standard vector and a target environmental vector respectively; and
a real-time body temperature weighted-calibration module, wherein the real-time body temperature weighted-calibration module is configured to perform weighted calibration on the first real-time body temperature with an individual similarity coefficient between the individual standard vector and the target individual vector and an environmental similarity coefficient between the environmental standard vector and the target environmental vector as weights, so as to obtain the first effective real-time body temperature; and
the central management platform further comprises a first similarity calculation module, wherein the first similarity calculation module is configured to calculate a similarity between the individual standard vector and the target individual vector through a cosine similarity principle, so as to obtain a first similarity;
a second similarity calculation module, wherein the second similarity calculation module is configured to count a vector consistency number of the individual standard vector and the target individual vector, obtain a ratio of the vector consistency number to a total vector number, and record the ratio as a second similarity; and
an individual similarity coefficient obtaining module, wherein the individual similarity coefficient obtaining module is configured to take an average value of the first similarity and the second similarity, and record the average value as the individual similarity coefficient.

2. The system according to claim 1, wherein the intelligent wearable body temperature monitoring device further comprises a real-time body temperature time sequence obtaining module, wherein the real-time body temperature time sequence obtaining module is configured to obtain a first real-time body temperature time sequence of the first human body part through the first body temperature sensor;
a regression fitting module, wherein the regression fitting module is configured to perform polynomial regression fitting on a first body temperature scatter diagram drawn according to the first real-time body temperature time sequence, so as to obtain a first fitting formula; and
a real-time body temperature checking module, wherein the real-time body temperature checking module is configured to analyze the first fitting formula to obtain a first real-time predicted body temperature, and check the first real-time body temperature through the first real-time predicted body temperature.

3. The system according to claim 2, wherein the intelligent wearable body temperature monitoring device further comprises a circuit wake-up module, wherein the circuit wake-up module is configured to activate a timed wake-up circuit, and the timed wake-up circuit is provided with an identifier of a predetermined time interval; and
a body temperature monitoring module, wherein the body temperature monitoring module is configured to wake up the first body temperature sensor to perform dynamic body temperature monitoring on the first human body part based on the predetermined time interval, so as to obtain the first real-time body temperature time sequence.

4. The system according to claim 1, wherein the data transmission module performs data transmission through Bluetooth, wireless fidelity (WiFi), or a radio frequency technology at a specific frequency band.

5. The system according to claim 1, further comprising an intelligent alarming module, wherein the intelligent alarming module specifically comprises a body temperature threshold determination module, wherein the body temperature threshold determination module is configured to determine whether the first effective real-time body temperature satisfies a predetermined body temperature threshold;
an alarming signal sending module, wherein the alarming signal sending module is configured to send an alarming signal if the first effective real-time body temperature does not satisfy the predetermined body temperature threshold; and
an abnormality alarming module, wherein the abnormality alarming module is configured to invoke a predetermined alarming mechanism based on the alarming signal, so as to provide a body temperature abnormality alarm of the target user, wherein
the predetermined alarming mechanism reminds a worker at least through sound, flashing, and a pop-up window.

6. The system according to claim 5, wherein the intelligent alarming module is further configured to obtain real-time positioning information of the target user through a positioning sensor, and add the real-time positioning information to the body temperature abnormality alarm.
